(19) United States
(12) Patent Application Publication
(10) Pub. No.: US 2012/0146344 A1
(43) Pub. Date: Jun. 14, 2012

(54) SMART LATCH SYSTEMS

(76) Inventor: John Markou, Barrie (CA)

(21) Appl. No.: 13/313,119

(22) Filed: Dec. 7, 2011

Related U.S. Application Data
(60) Provisional application No. 61/422,366, filed on Dec. 13, 2010.

(51) Int. Cl. E05C 1/10; B23P 11/00

(52) U.S. Cl. 292/161; 292/143; 29/428

(57) ABSTRACT

A gate fastening latch system comprising: a housing; two fasteners; vertical slide slots comprising guides (guiding movement relative); and a striker body assembly including a striker bolt and a securing plate assembly having threaded receivers. The housing includes a front face; a rear face; a top face; a bottom face; a left face; a right face; a top lug; a bottom lug; and an inner volume. The front face; rear face; top face; bottom face; the left face; the right face, and the inner volume define confines of the housing. Further, the top face; the bottom face; the left face; and the right face form a boxed structure frame to surround and maintain the inner volume. The gate fastening latch system provides that the swinging gate is able to be repeated coupled to a latch body on a structure via the striker bolt; the system being adjustable.

### CROSS-REFERENCE TO RELATED APPLICATION

The present application is related to and claims priority from prior provisional application Ser. No. 61/422,366, filed Dec. 13, 2010 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of latches and more specifically relates to smart latches for use with swinging doors.

2. Description of the Related Art

A gate is a point of entry to a space enclosed by walls, or a moderately sized opening in a fence. Gates may prevent or control entry or exit, or they may be merely decorative. A latch is a type of mechanical fastener that may be used to join two (or more) objects or surfaces together while allowing for the regular or eventual separation of the objects or surfaces. A latch is a device useful for holding a door, gate, or the like, closed, consisting basically of a bar falling or sliding into a catch, groove, hole, or the like.

A latch typically engages another piece of hardware on the adjacent mounting surface. Depending upon the type and design of the latch, this engaging hardware may be known as a keeper or strike. Latches range in complexity from flexible one piece flat springs of metal or plastic, such as are used to keep blow molded plastic power tool cases closed, to multi-point cammed latches used to keep large doors closed.

Unfortunately, standard wooden gates may warp over time, causing them to be off center when attempting to close. This may cause an individual to repeatedly manually latch and adjust the fence, which may be frustrating. A gate may not constantly latch allowing the gate to inadvertently remain open, which may compromise safety of the residence or allow pets to leave an otherwise enclosed area or allow predators in. Having a wooden gate latch that can consistently engage to prevent a gate from remaining open may assist individuals in having peace of mind that their gate will remain shut.

Various attempts have been made to solve the above-mentioned problems such as those found in U.S. Pat. Nos. 4,305,611; 6,752,438; 5,375,296; 2,615,194; 126,191; and 686,025. This prior art is representative of latches. None of the above inventions and patents, taken either singly or in combination, is seen to describe the invention as claimed.

Ideally, a latch should require a minimum of maintenance be readily adjustable and yet, would operate reliably and be manufactured at a modest expense. Thus, a need exists for a reliable smart latch system to avoid the above-mentioned problems.

### BRIEF SUMMARY OF THE INVENTION

In view of the foregoing disadvantages inherent in the known latch art, the present invention provides a novel smart latch system. The general purpose of the present invention, which will be described subsequently in greater detail is to provide a readily adjustable swinging door/gate latch.

A gate fastening latch system is disclosed herein, a preferred embodiment comprising: a housing; two fasteners preferably comprising two bolts and two washers; exactly two vertical slide slots comprising guides; and a striker body assembly. The housing includes a front face; a rear face; a top face; a bottom face; a left face; a right face; a top lug; a bottom lug; and an inner volume. The front face; rear face; top face; bottom face; the left and right faces, and the inner volume define confines of the housing. Further, the top face; the bottom face; the left face; and the right face form a boxed structure frame to surround and maintain the inner volume surrounding structure. The housing is about ⅛″ thick, about 3″ long, and about ½″ wide in preferred embodiments.

The striker body assembly includes a striker bolt; and a securing plate assembly having at least one threaded receiver. The striker body assembly is removable from the housing. The securing plate assembly is preferably integral with the striker bolt. The gate fastening latch system provides that the swinging gate is able to be repeated coupled to a latch body on a structure via the striker bolt. The latch body comprises a tongue slot suitable to rotatably-receive and hold steadfast the striker bolt when the swinging gate is in a closed condition (from an open position, and allow release of striker bolt permitting swinging gate to move to an open condition.) The back of the housing preferably comprises six (more or less) U-shaped notches and four 90-degree bends, allowing the striker body assembly to move both vertically and horizontally in relation to the housing.

The top lug comprises at least one top aperture while the bottom lug comprises at least one bottom aperture (2 each in preferred embodiments.) The top lug and the bottom lug are provided such that the housing is attachable to a swinging gate. The swinging gate comprises wood or other suitably equivalent material. The top lug comprises two of top apertures, the top apertures comprising top-horizontally-oriented-slots. The bottom lug comprises two of the bottom apertures, the bottom apertures comprising bottom-horizontally-oriented-slots (elliptical or other suitable shape.) The housing is attachable to the structure via screws inserted through the top aperture of the top lug. The housing is attachable to the structure via screws inserted through the bottom aperture of the bottom lug.

The fastener(s) are used to hold the striker body assembly in stasis with the rear face of the housing, the fastener(s) entering the housing via the vertical slide slot(s) from the front face, passing into the inner volume, the fasteners being received by the threaded receivers in the securing plate assembly (to affix the assembly together.) The rear face of the housing is adjacent the swinging gate when coupled thereto. The gate fastening latch system is adjustable vertically by loosening the fasteners and moving the striker body assembly in coupled combination with the fasteners along the vertical slide slots, then retightening the fasteners. The vertical slide slots are perpendicular to the striker body assembly.

A kit is described herein including the housing, the fasteners, the screws, the striker body assembly and a set of user instructions.

A method of using a gate fastening latch system is also disclosed herein preferably comprising the steps of: fastening a striker body assembly to a housing to form a gate fastening latch assembly; attaching the gate fastening latch assembly to a swinging gate; coupling the swinging gate with a latch body located on a fixed structure and adjusting the striker body assembly horizontally and vertically relative to the housing to accommodate for changes in location of the latch body relative to the gate fastening latch assembly.

The present invention holds significant improvements and serves as a gate fastening latch system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, gate fastening latch system, constructed and operative according to the teachings of the present invention.

FIG. 1 shows a perspective view illustrating a housing of a gate fastening latch system according to an embodiment of the present invention.

FIG. 2 is a perspective view illustrating a striker body assembly as coupled to the housing creating a gate fastening latch assembly in its upper-most adjusted position according to an embodiment of the present invention of FIG. 1.

FIG. 3 is a perspective view illustrating the striker body assembly as coupled to the housing creating a gate fastening latch assembly in its lower-most adjusted position according to an embodiment of the present invention of FIG. 1.

FIG. 4 is a perspective view illustrating the gate fastening latch system in an in-use condition according to an embodiment of the present invention of FIG. 1.

FIG. 5 is a flowchart illustrating a method of using the gate fastening latch system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a latch device and more particularly to a smart latch as used to provide a readily adjustable gate latch.

Generally speaking, the smart latch flange provides consumers with a efficient way to manually latch a wooden gate without the device loosening, which may be the case when employing standard latches. This unique product can assist users in effectively latching a gate with little effort so that it may close properly and remain shut. This innovative item is ideal for use by virtually anyone with a wooden gate so that the existing gate may consistently remain centered when latched. The smart latch flange is a device that can be utilized on a wooden fence to provide secure fastening of a gate each time it is manually closed. This item may be comprised of a small, metal housing (flange) with six notches and four 90-degree bends, allowing it to move both vertically and horizontally. The flange may measure approximately ⅛″ thick, 3″ long, and ½″ wide. The striker part of the latch may have the ability to glide into the most efficient spot desired by the user. It may then be tightened and remain in place until the user chooses to move it. The latch may then be fastened in a traditional manner. This item may be bolted in place on a standard wooden fence by screws. The flange can also be integrated with existing gate-latching systems by simply adding it to the system.

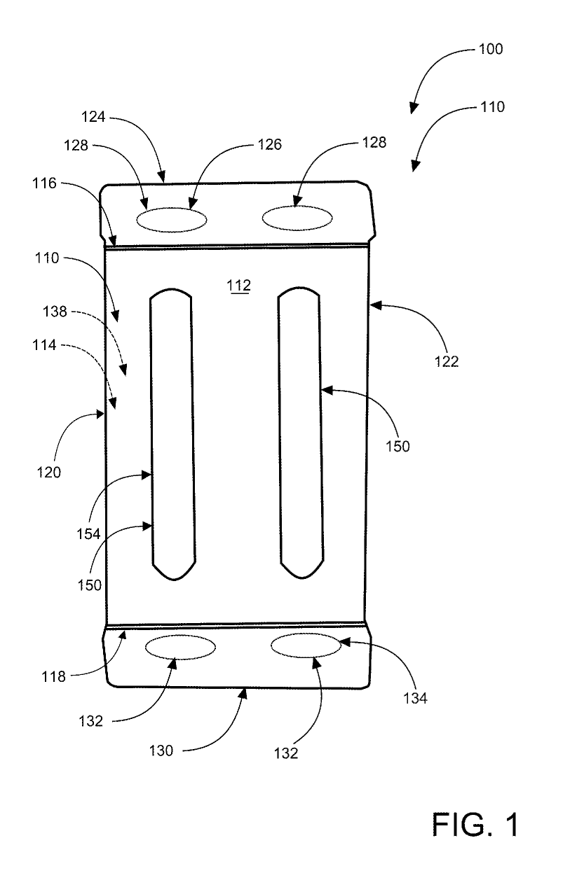

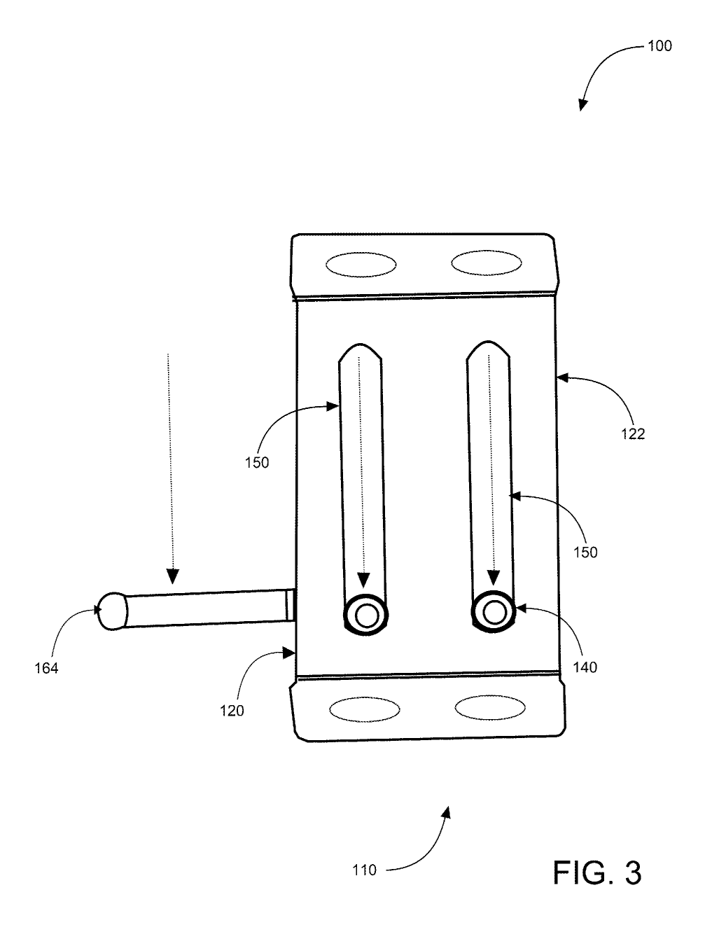

Referring now to the drawings by numerals of reference there is shown in FIGS. 1-4, various views of gate fastening latch system 100 according to an embodiment of the present invention.

Gate fastening latch system 100 is disclosed herein, a preferred embodiment comprising: housing 110; at least one fastener 140; at least one vertical slide slot 150 comprising guide(s) 154; and striker body assembly 160. Housing 110 includes front face 112; rear face 114; top face 116; bottom face 118; left face 120; right face 122; top lug 124; bottom lug 130; and inner volume 138 as shown best in FIG. 1. Front face 112; rear face 114; top face 116; bottom face 118; left face 120; right face 122, and inner volume 138 define confines of housing 110. Further, top face 116; bottom face 118; left face 120; and right face 122 form a boxed structure frame to surround and maintain (give strength to in structural stability) inner volume 138. Housing 110 is about ⅛″ thick, about 3″ long, and about ½″ wide in preferred embodiments.

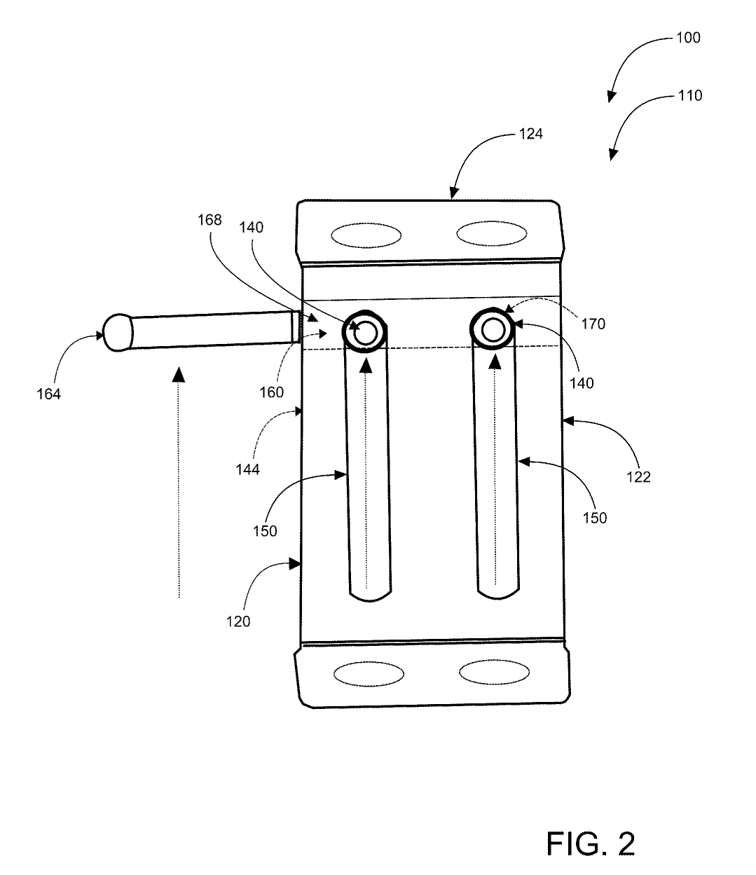

Striker body assembly 160 includes striker bolt 164; and securing plate assembly 168 as shown best in FIGS. 2 & 3. Securing plate assembly 168 may include at least one threaded receiver 170. Striker body assembly 160 is preferably removable from housing 110 via unthreading fastener 140 from threaded receiver 170. Further, securing plate assembly 168 is integral with striker bolt 164. A back region of housing 110 comprises notches 144 and four 90-degree bends, preferably allowing striker body assembly 160 to move both vertically and horizontally in relation to housing 110. Housing 110 includes preferably six notches 144, however more or less than six notches 144 may be suitably used. Notches 144 each preferably comprises a U-shape. Upon reading this specification, it should be appreciated that, under appropriate circumstances, considering such issues as user preferences, design preference, structural requirements, marketing preferences, cost, available materials, technological advances, etc., other shape arrangements such as, for example, V-shaped, W-Shaped, etc., may be sufficient.

Top lug 124 comprises at least one top aperture 126 while bottom lug 130 comprises at least one bottom aperture 132. Top lug 124 and bottom lug 130 are provided such that housing 110 is attachable to swinging gate 190. Swinging gate 190 preferably comprises wood. Upon reading this specification, it should be appreciated that, under appropriate circumstances, considering such issues as user preferences, design preference, structural requirements, marketing preferences, cost, available materials, technological advances, etc., other material arrangements such as, for example, plastic, metal, non-metal, etc., may be sufficient.

Top lug 124 preferably comprises two of top apertures 126, top apertures 126 comprising top-horizontally-oriented-slots 128. Bottom lug 130 preferably comprises two of bottom apertures 132, bottom apertures 132 preferably comprising bottom-horizontally-oriented-slots 134. Housing 110 is preferably attachable to gate fastening latch system 100 via screws inserted through top aperture 126 of top lug 124. Housing 110 is also preferably attachable to the gate fastening latch system 100 via screws inserted through bottom aperture 132 of bottom lug 130. Upon reading this specification, it should be appreciated that, under appropriate circumstances, considering such issues as user preferences, design preference, structural requirements, marketing preferences, cost, available materials, technological advances, etc., other fastener arrangements such as, for example, nuts and bolts, nails, rivets, etc., may be sufficient.

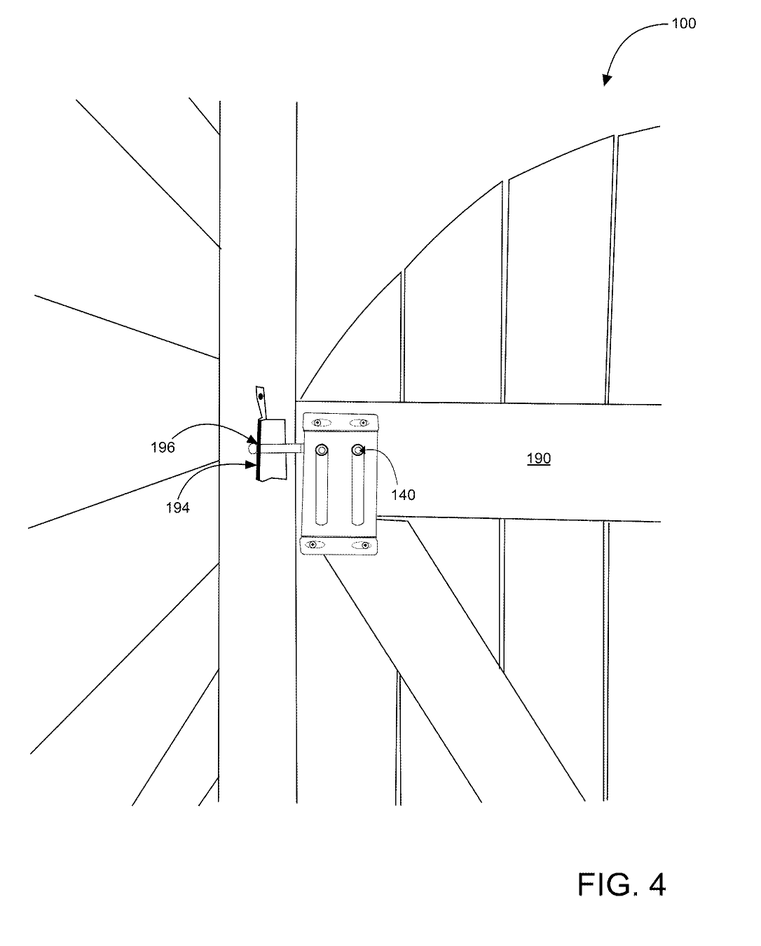

Gate fastening latch system 100 may provide that the swinging gate 190 is able to be repeated coupled to latch body 194 on a structure via striker bolt 164. Latch body 194 comprises tongue slot 196 suitable to rotatably-receive and hold steadfast striker bolt 164 when swinging gate 190 is in an open or a closed condition as shown best in ‘in-use condition 400 of FIG. 4. Gate fastening latch system 100 is adjustable vertically by loosening the fastener(s) 140 and moving striker body assembly 160 in coupled combination with the fastener(s) 140 along the vertical slide slot(s) 150, then retightening fastener(s) 140. Gate fastening latch system 100 preferably comprises exactly vertical slide slot(s) 150; however more or less vertical slide slot(s) 150 may be used. Vertical slide slot(s) 150 is preferably perpendicular to striker body assembly 160.

Fastener(s) 140 may be used to hold striker body assembly 140 in stasis with rear face 114 of housing 110, fastener(s) 140 entering housing 110 via vertical slide slot(s) 150 from front face 112, passing into inner volume 138, fastener(s) 140 being received by threaded receiver(s) 170 in securing plate assembly 168. Rear face 114 of housing 110 is preferably adjacent swinging gate 190 when coupled thereto. Fastener(s) 140 preferably comprise two bolts and two washers (washers to provide surface area distribution); however more or less bolts and/or washer may be used. Upon reading this specification, it should be appreciated that, under appropriate circumstances, considering such issues as user preferences, design preference, structural requirements, marketing preferences, cost, available materials, technological advances, etc., other fastener arrangements such as, for example, screws, studs, etc., may be sufficient

Gate fastening latch system 100 may be sold as kit 440 comprising: housing 110, fastener(s) 140, screws, striker body assembly 160; and a set of user instructions; kit 440 for retro-fitting to an existing swinging gate 190. Gate fastening latch system 100 may be manufactured and provided for sale in a wide variety of sizes and shapes for a wide assortment of latching applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, parts may be sold separately, etc., may be sufficient.

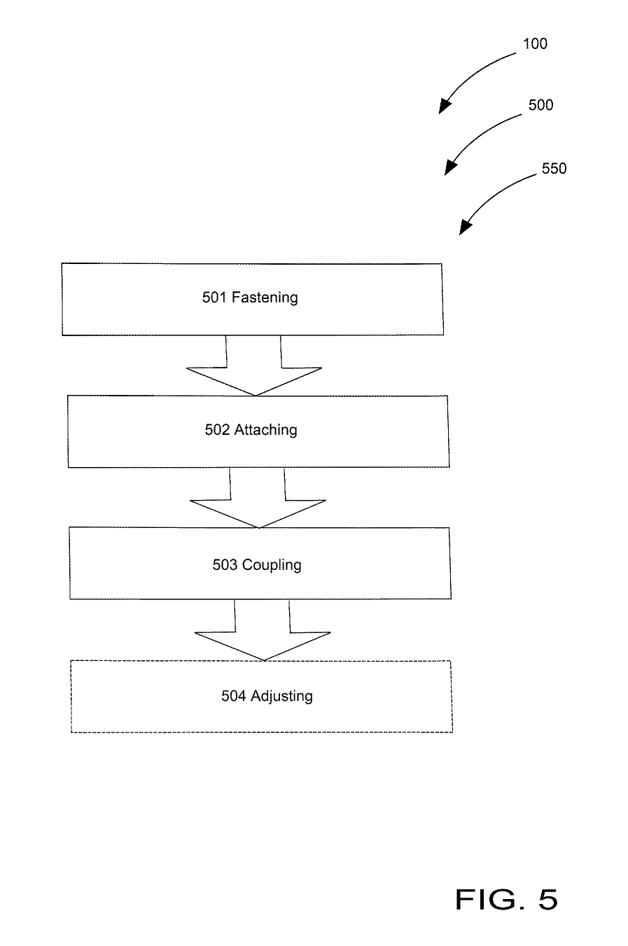

Referring now to FIG. 5, a flowchart 550 illustrating a method of using (method of use 500) for gate fastening latch system 100 according to an embodiment of the present invention of FIGS. 1-4. A method of using (method of use 500) gate fastening latch system 100 is also disclosed herein preferably comprising the steps of: step one 501 fastening striker body assembly 160 to housing 110 forming a gate fastening latch assembly; step two 502 attaching the gate fastening latch assembly to swinging gate 190; step three 503 coupling swinging gate 190 with latch body 194 located on a fixed structure; and step four 504 adjusting striker body assembly 160 horizontally and vertically relative to housing 110 to accommodate for changes in location (alignment) of latch body 194 relative to the gate fastening latch assembly.

It should be noted that step four 504 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A gate fastening latch system comprising:
a housing having;
a front face;
a rear face;
a top face;
a bottom face;
a left face;
a right face;
a top lug;
a bottom lug; and
an inner volume;
at least one fastener;
at least one vertical slide slot;
a striker body assembly having;
a striker bolt; and
a securing plate assembly having at least one threaded receiver;
wherein said front face; said rear face; said top face; said bottom face; said left face; said right face, and said inner volume define confines of said housing;
wherein said top face; said bottom face; said left face; and said right face form a boxed structure frame to surround and maintain said inner volume;
wherein said top lug comprises at least one top aperture;
wherein said bottom lug comprises at least one bottom aperture;
wherein said top lug and said bottom lug are provided such that said housing is attachable to a swinging gate;
wherein said rear face of said housing is adjacent said swinging gate when coupled thereto;
wherein said fastener(s) are used to hold said striker body assembly in stasis with said rear face of said housing, said fastener(s) entering said housing via said vertical slide slot(s) from said front face, passing into said inner volume, said fasteners being received by said threaded receivers in said securing plate assembly;
wherein said securing plate assembly is integral with said striker bolt;
wherein said gate fastening latch system is adjustable vertically by loosening said fasteners and moving said striker body assembly in coupled combination with said fasteners along said vertical slide slots, then retightening said fasteners, and
wherein said gate fastening latch system provides that said swinging gate is able to be repeated coupled to a latch body on a structure via said striker bolt.

2. The gate fastening latch system of claim 1 wherein said back of said housing comprises a plurality of notches and four 90-degree bends, allowing said striker body assembly to move both vertically and horizontally in relation to said housing.

3. The gate fastening latch system of claim 2 wherein said housing is about ⅛″ thick, about 3″ long, and about ½″ wide.

4. The gate fastening latch system of claim 1 wherein said top lug comprises two of said top apertures, said top apertures comprising top-horizontally-oriented-slots.

5. The gate fastening latch system of claim 1 wherein said bottom lug comprises two of said bottom apertures, said bottom apertures comprising bottom-horizontally-oriented-slots.

6. The gate fastening latch system of claim 1 wherein said gate fastening latch system comprises exactly two said vertical slide slots.

7. The gate fastening latch system of claim 6 wherein said vertical slide slots comprise guides.

8. The gate fastening latch system of claim 1 wherein said latch body comprises a tongue slot suitable to rotatably-receive and hold steadfast said striker bolt when said swinging gate is in a closed condition.

9. The gate fastening latch system of claim 8 wherein said latch body comprising said tongue slot, wherein said tongue slot is rotatable to allow release of said striker bolt permitting said swinging gate to move to an open condition.

10. The gate fastening latch system of claim 1 wherein said housing is attachable to said structure via screws inserted through said top aperture of said top lug.

11. The gate fastening latch system of claim 1 wherein said housing is attachable to said structure via screws inserted through said bottom aperture of said bottom lug.

12. The gate fastening latch system of claim 2 comprises six of said notches.

13. The gate fastening latch system of claim 12 wherein each of said notches comprises a U-shape.

14. The gate fastening latch system of claim 1 wherein said swinging gate comprises wood.

15. The gate fastening latch system of claim 1 wherein said vertical slide slots are perpendicular to said striker body assembly.

16. The gate fastening latch system of claim 1 wherein said striker body assembly is removable from said housing.

17. A gate fastening latch system comprising:
a housing having;
a front face;
a rear face;
a top face;
a bottom face;
a left face;
a right face;
a top lug;
a bottom lug; and
an inner volume;
exactly two vertical slide slots comprising guides;
two fasteners comprising two bolts and two washers; and
a striker body assembly having;
a striker bolt; and
a securing plate assembly having two threaded receivers;
wherein said front face; said rear face; said top face; said bottom face; said left face; said right face, and said inner volume define confines of said housing;
wherein said top face; said bottom face; said left face; and said right face form a boxed structure frame to surround and maintain said inner volume;
wherein said top lug comprises two top apertures;
wherein said bottom lug comprises two bottom apertures;
wherein said top lug and said bottom lug are provided such that said housing is attachable to a swinging gate;
wherein said swinging gate comprises wood;
wherein said top lug comprises exactly two of said top apertures, said top apertures comprising top-horizontally-oriented-slots;
wherein said bottom lug comprises exactly two of said bottom apertures, said bottom apertures comprising bottom-horizontally-oriented-slots;
wherein said rear face of said housing is adjacent said swinging gate when coupled thereto;
wherein said housing is about ⅛″ thick, about 3″ long, and about ½″ wide;
wherein said bolt said fastener(s) are used to hold said striker body assembly in stasis with said rear face of said housing, said fastener(s) entering said housing via said vertical slide slot(s) from said front face passing through said washers located in front of said front face, said bolts passing into said inner volume, said fasteners being threadably-received by said threaded receivers in said securing plate assembly;
wherein said securing plate assembly is integral with said striker bolt;
wherein said vertical slide slots are perpendicular to said striker body assembly;
wherein said striker body assembly is removable from said housing;
wherein said back of said housing comprises six notches and four 90-degree bends, allowing said striker body assembly to move both vertically and horizontally in relation to said housing;
wherein each of six said notches comprises a U-shape;
wherein said gate fastening latch system is adjustable vertically by loosening said fasteners and moving said striker body assembly in coupled combination with said fasteners along said vertical slide slots, then retightening said fasteners;
wherein said housing is attachable to said structure via screws inserted through said top aperture of said top lug and said bottom aperture of said bottom lug;
wherein said screws are screwed into said swinging gate; and
wherein said gate fastening latch system provides that said swinging gate is able to be repeated coupled to a latch body on a fixed structure via said striker bolt.

18. The gate fastening latch system of claim 17 further comprising a kit including said housing, said fasteners, said screws, said striker body assembly and a set of user instructions.

19. A method of using a gate fastening latch system comprising the steps of:
fastening a striker body assembly to a housing to form a gate fastening latch assembly;
attaching said gate fastening latch assembly to a swinging gate; and
coupling said swinging gate with a latch body located on a fixed structure.

20. The method of claim 19 further comprising the step of adjusting said striker body assembly horizontally and vertically relative to said housing to accommodate for changes in alignment of said latch body relative to said gate fastening latch assembly.
